(19) United States
(12) Patent Application Publication
(10) Pub. No.: US 2025/0075846 A1
(43) Pub. Date: Mar. 6, 2025

(54) Supporting Arm

(71) Applicant: NINGBO TUOTUO RIVER DESIGN COMPANY, Ningbo (CN)

(72) Inventors: Hongjun WANG, Ningbo (CN); Yijun LIU, Ningbo (CN)

(73) Assignee: NINGBO TUOTUO RIVER DESIGN COMPANY, Ningbo (CN)

(21) Appl. No.: 18/818,950

(22) Filed: Aug. 29, 2024

(30) Foreign Application Priority Data
Aug. 30, 2023 (CN) 202322349477.8

(51) Int. Cl. F16M 11/10

(52) U.S. Cl. CPC F16M 11/10; F16M 2200/041; F16M 2200/063; F16M 2200/066

(57) ABSTRACT

A supporting arm is provided. The supporting arm includes a first mounting seat, a second mounting seat, a supporting member and a force applying member. Two opposite ends of the supporting member are configured to be rotatably connected to the first mounting seat and the second mounting seat, respectively. The force applying member is arranged between the first mounting seat and the second mounting seat. The force applying member includes at least two elastic members nested sequentially from inside to outside, and the at least two elastic members jointly provide a supporting force, such that the second mounting seat is kept at any rotation position of the first mounting seat.

### CROSS-REFERENCE TO RELATED APPLICATION

The present disclosure claims priority to Chinese Patent Application No. 202322349477.8, filed with the China National Intellectual Property Administration on Aug. 30, 2023 and entitled “Supporting Arm”, the entire contents of which are incorporated herein by reference for all purposes.

### TECHNICAL FIELD

The disclosure relates to the technical field of display supports, and particularly relates to a supporting arm.

### BACKGROUND

At present, mainstream displays in the market tend to be high in bearing performance, which requires display supports capable of bearing those displays having high bearing performance.

In a prior art, a large-bearing display support is provided with a mechanical spring. Its bearing capacity is generally increased by increasing a size of the spring, which leads to a large size of the spring in the support. Thus, an entire display support can have a large size. The bearing capacity increased by increasing the size of the spring is limited, resulting in a small bearing range of the display support.

### SUMMARY

An embodiment of the disclosure is to provide a supporting arm, so as to solve problems of a large size and a small bearing range of the supporting arm in the prior art.

Some embodiments of the disclosure provide a supporting arm. The supporting arm includes: a first mounting seat; a second mounting seat; a supporting member, wherein two opposite ends of the supporting member are configured to be rotatably connected to the first mounting seat and the second mounting seat, respectively; and a force applying member arranged between the first mounting seat and the second mounting seat, wherein the force applying member includes at least two elastic members nested sequentially from inside to outside, and the at least two elastic members jointly provide a supporting force, such that the second mounting seat is kept at any rotation position of the first mounting seat.

Further, at least one side of the force applying member is provided with the supporting member. The supporting member includes a first connecting rod and a second connecting rod. A first end of the first connecting rod and a first end of the second connecting rod are both pivotally connected to the first mounting seat. A second end of the first connecting rod and a second end of the second connecting rod are both pivotally connected to the second mounting seat. The first connecting rod, the second connecting rod, the first mounting seat and the second mounting seat form a quadrilateral structure. The quadrilateral structure is kept at any deformation position by the force applying member.

Further, the supporting arm further includes: a connecting member connected to the second connecting rod; and a stopping member connected to the first connecting rod or the first mounting seat. The at least two elastic members are located between the connecting member and the stopping member. Two opposite ends of each of the at least two elastic members are connected to the connecting member and the stopping member, respectively.

Further, the at least two elastic members are two compression springs. The stopping member includes a first stopping section and a second stopping section that are connected to each other. A cross-sectional area of the first stopping section is larger than a cross-sectional area of the second stopping section. A compression spring located at an outer side of the two compression springs sleeves the second stopping section and abuts against the first stopping section. A compression spring located at an inner side of the two compression springs abuts against the second stopping section.

Further, the stopping member includes at least two stopping sections which are connected and whose cross-sectional areas decrease sequentially. The at least two elastic members correspondingly abut against the at least two stopping sections.

Further, the stopping member is movably arranged along an axis of the elastic members. A side of the second connecting rod facing the force applying member is provided with a guide groove. The stopping member is in sliding fit with the guide groove.

Further, the supporting arm further includes a limiting member connected to the second connecting rod. At least part of the limiting member is arranged at an included angle with the second connecting rod. The limiting member is at least located at a circumferential side of the force applying member, such that the force applying member is prevented from falling off.

Further, the supporting arm further includes: a guide sleeve; and a guide rod in sliding fit with the guide sleeve. The force applying member is located on an outer circumference of both the guide sleeve and the guide rod, such that the force applying member is to be guided.

Further, the supporting arm further includes a housing connected to the supporting member. The housing covers an outer circumference of two supporting members and the force applying member.

Further, the housing includes an upper cover plate, a left cover plate and a right cover plate that are connected and arranged at an included angle, so as to form a U-shaped structure provided with a mounting cavity; or, the supporting arm further includes a lower cover plate connected to the supporting member, and the lower cover plate is located on a bottom of the supporting member; or, a number of the supporting members is two, and the two supporting members are located at a left side and a right side of the force applying member, respectively.

In the prior art, a spring having a large size is used to increase bearing capacity of a display support. Compared with that, through the technical solution of the disclosure, a large spring is transformed into a plurality of small elastic members for nested mounting from inside to outside in the embodiments, and the plurality of elastic members jointly provide the supporting force. In this way, on one hand, internal space of the elastic members can be used, which not only increases bearing capacity of the supporting arm, but also avoids increase in a size of the supporting arm; and on the other hand, under the condition that the springs occupy a same space as the spring in the prior art, the supporting arm in the embodiments of the present disclosure has a larger bearing range, and the bearing range of the supporting arm can be increased by increasing the number of elastic members.

### BRIEF DESCRIPTION OF THE DRAWINGS

Drawings of the description as a constituent part of the disclosure are used to provide further understanding of the disclosure, and illustrative examples of the disclosure and the description thereof are used to explain the disclosure, which are not intended to unduly limit the disclosure. In the drawings:

FIG. 1 is a schematic structural diagram of an embodiment of a supporting arm according to the disclosure;

FIG. 2 is a schematic structural diagram of an exploded view of the supporting arm of FIG. 1;

FIG. 3 is a schematic structural diagram of a supporting member and a force applying member of the supporting arm of FIG. 2;

FIG. 4 is a schematic diagram of a structure in which a second mounting seat of the supporting arm of FIG. 1 is located at an uppermost position;

FIG. 5 is a schematic diagram of a structure in which a second mounting seat of the supporting arm of FIG. 1 is located at a middle position;

FIG. 6 is a schematic diagram of a structure in which a second mounting seat of the supporting arm of FIG. 1 is located at a lowermost position; and

FIG. 7 is a schematic structural diagram of another embodiment of a supporting arm of the disclosure (in which a guide rod is connected to a first mounting seat).

The above figures include the following reference numerals:
1, first mounting seat; 2, second mounting seat; 10, supporting member; 11, first connecting rod; 12, second connecting rod; 13, guide groove; 15, limiting member; 21, elastic member; 22, guide rod; 23, guide sleeve; 24, connecting member; 25, stopping member; 251, first stopping section; 252, second stopping section; 30, housing; 31, lower cover plate.

### DETAILED DESCRIPTION OF THE EMBODIMENTS

It should be noted that examples in the disclosure and features in the examples can be combined with one another if there is no conflict. The disclosure will be described in detail below with reference to the accompanying drawings and the examples.

It should be noted that a supporting arm of the example of the disclosure is used for a display support.

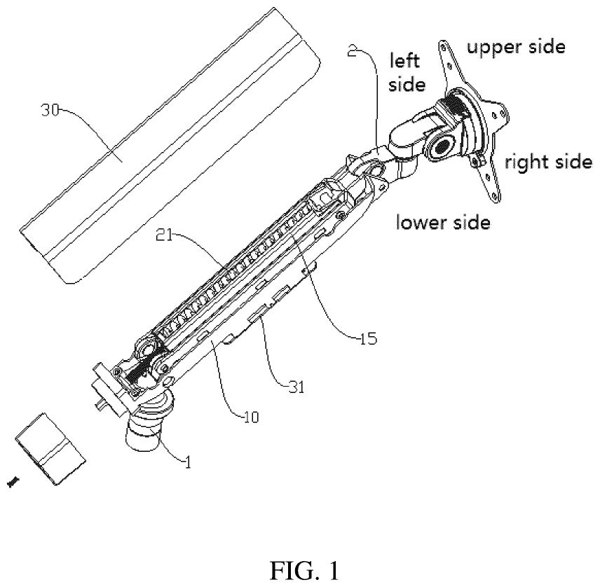

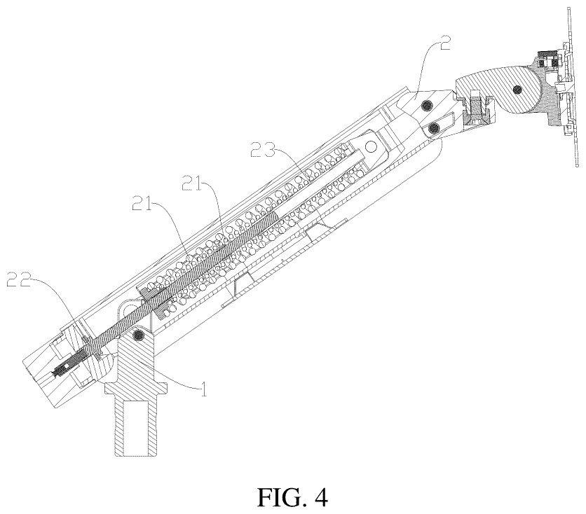

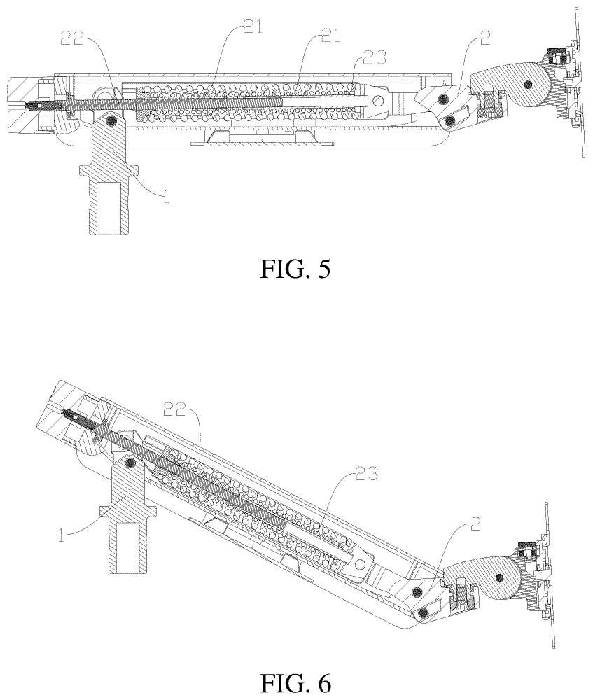

As shown in FIGS. 1-7, some embodiments of the disclosure provide a supporting arm. The supporting arm includes a first mounting seat 1, a second mounting seat 2, a supporting member 10, and a force applying member. Two opposite ends of the supporting member 10 are configured to be rotatably connected to the first mounting seat 1 and the second mounting seat 2, respectively. The force applying member is arranged between the first mounting seat 1 and the second mounting seat 2. The force applying member includes at least two elastic members 21 nested sequentially from inside to outside. The at least two elastic members 21 jointly provide a supporting force, such that the second mounting seat 2 is kept at any rotation position of the first mounting seat 1.

In a prior art, a spring having a large size is used to increase bearing capacity of a display support. Compared with that, in the embodiments of present disclosure, a large spring is transformed into a plurality of small elastic members for nested mounting from inside to outside, and the plurality of elastic members 21 jointly provide the supporting force. In this way, on one hand, internal space of the elastic members 21 can be used, which not only increases bearing capacity of the supporting arm, but also avoids increase in a size of the supporting arm; and on the other hand, under the condition that the springs occupy the same space as the spring in the prior art, the supporting arm in the embodiments has a larger bearing range, and the bearing range of the supporting arm can be increased by increasing the number of elastic members 21.

Specifically, in some embodiments of the disclosure, the first mounting seat 1 is fixedly mounted on a to-be-mounted base, and the second mounting seat 2 is configured to mount a display. Clearly, in an embodiment, the second mounting seat 2 may also be mounted on the to-be-mounted base, such that the display is mounted on the first mounting seat 1.

As shown in FIGS. 1-3, in some embodiments of the disclosure, at least one side of the force applying member is provided with the supporting member 10, the supporting member 10 includes a first connecting rod 11 and a second connecting rod 12, a first end of the first connecting rod 11 and a first end of the second connecting rod 12 are both pivotally connected to the first mounting seat 1, a second end of the first connecting rod 11 and a second end of the second connecting rod 12 are both pivotally connected to the second mounting seat 2, and the first connecting rod 11, the second connecting rod 12, the first mounting seat 1 and the second mounting seat 2 form a quadrilateral structure. The quadrilateral structure is kept at any deformation position by the force applying member.

Through the above arrangement, the force applying member and the supporting member 10 may jointly support the second mounting seat 2, and the quadrilateral structure is able to be kept at any deformation position. In this way, the second mounting seat 2 may be kept at any rotation position of the first mounting seat 1, such that the display may be kept at any position.

Specifically, in some embodiments of the disclosure, the quadrilateral structure is a parallelogram structure. The first connecting rod 11 and the second connecting rod 12 are arranged in parallel, and the first connecting rod 11 is located above the second connecting rod 12.

It should be noted that in some embodiments of the disclosure, four intersections of a quadrilateral are all pivot points, and a relative positional relation between four sides of the quadrilateral may be changed. The quadrilateral structure may be kept at any deformation position, which indicates that the four sides of the quadrilateral may be kept at any relative positions.

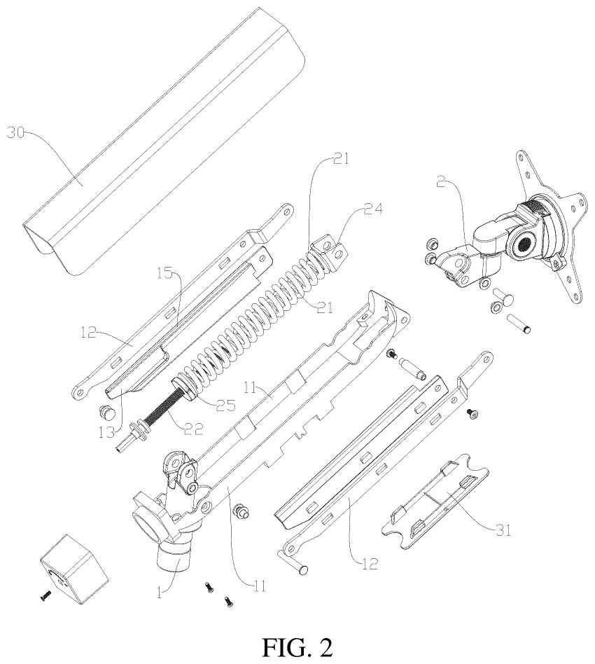

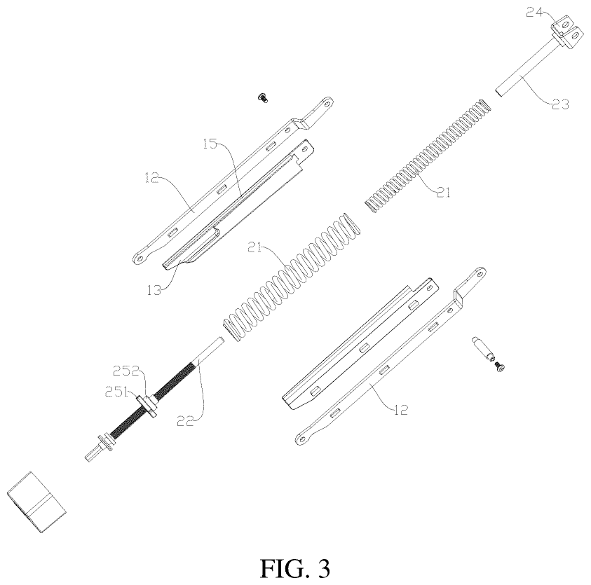

As shown in FIGS. 2 and 3, in some embodiments of the disclosure, the supporting arm further includes a connecting member 24 and a stopping member 25. The connecting member 24 is connected to the second connecting rod 12. The stopping member 25 connected to the first connecting rod 11. The at least two elastic members 21 are located between the connecting member 24 and the stopping member 25. Two opposite ends of each of the at least two elastic members 21 are connected to the connecting member 24 and the stopping member 25, respectively.

Through the above arrangement, the elastic members 21 may fix the second connecting rod 12 relative to the first connecting rod 11, such that the second mounting seat 2 is fixed relative to the first mounting seat 1, and the display on the second mounting seat 2 is kept at a fixed position relative to the to-be-mounted base.

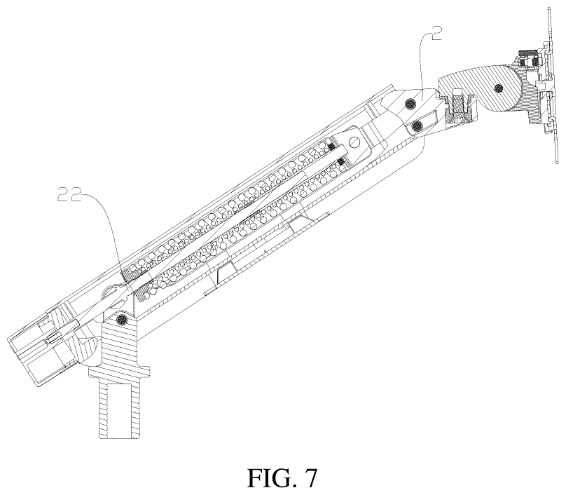

In an embodiment, as shown in FIG. 7, the stopping member 25 may also be connected to the first mounting seat 1.

As shown in FIG. 2, in some embodiments of the disclosure, the at least two elastic members 21 are two compression springs. The stopping member 25 includes a first stopping section 251 and a second stopping section 252 that are connected to each other. A cross-sectional area of the first stopping section 251 is larger than a cross-sectional area of the second stopping section 252. The compression spring located at an outer side of the two compression springs sleeves the second stopping section 252 and abuts against the first stopping section 251. The compression spring located at an inner side of the two compression springs abuts against the second stopping section 252.

Through the above arrangement, the compression spring may enable the stopping member 25 and the connecting member 24 to move away from each other. In this way, according to a principle of a parallelogram mechanism, the second connecting rod 12 may be fixed relative to the first connecting rod 11 or the first mounting seat 1, such that the display on the second mounting seat 2 may be kept at the fixed position relative to the to-be-mounted base.

Specifically, in some embodiments of the disclosure, the first stopping section 251 and the second stopping section 252 are able to abut against the two compression springs respectively, and the second stopping section 252 is able to guide the compression spring located at the outer side, such that dislocation of the compression spring located at the outer side is avoided.

In an embodiment, the at least two elastic members 21 may also be two tension springs. One end of each of the tension springs is connected to the first connecting rod 11, and the other end of each of the tension springs is connected to the second connecting rod 12 or the first mounting seat 1.

In some embodiments of the disclosure, a diameter of the compression spring located at the outer side is larger than a diameter of the compression spring located at the inner side, and a rotation direction of a large compression spring is opposite to a rotation direction of a small compression spring. That is, if the large compression spring is left-handed, the small compression spring is right-handed, such that instability of the compression spring can be prevented.

In an embodiment, the stopping member 25 includes at least two stopping sections which are connected to each other, and cross-sectional areas of the at least two stopping sections are sequentially decreased. The at least two elastic members 21 correspondingly abut against the at least two stopping sections. In this way, the stopping sections may abut against the at least two elastic members 21, and dislocation of each of the elastic members 21 is avoided, such that stability of the force applying member can be improved.

As shown in FIG. 2, in some embodiments of the disclosure, the stopping member 25 is movably arranged along an axis of the elastic members 21, a side of the second connecting rod 12 facing the force applying member is provided with a guide groove 13, and the stopping member 25 is in sliding fit with the guide groove 13.

Through the above arrangement, a distance between the stopping member 25 and the connecting member 24 is adjusted, such that elastic deformation of the elastic members 21 can be adjusted for supporting of displays having different weights. Moreover, the guide groove 13 may guide the stopping member 25, so as to move of the stopping member 25 easily.

As shown in FIGS. 2 and 3, in some embodiments of the disclosure, the supporting arm further includes a limiting member 15 connected to the second connecting rod 12. At least part of the limiting member 15 is arranged at an included angle with the second connecting rod 12. The limiting member 15 is at least located at a circumferential side of the force applying member, such that the force applying member is prevented from falling off. In this way, the elastic members 21 can be prevented from being separated from the supporting member 10, and the problem of instability of the compression spring located at the outer side when the force applying member is compressed can be avoided.

Specifically, in some embodiments of the disclosure, the second connecting rod 12 includes a connecting rod body and a connecting rod sheet connected to the connecting rod body. The connecting rod sheet is located at a side of the connecting rod body facing the elastic members 21.

The guide groove 13 is provided on the connecting rod sheet. The limiting member 15 is connected, with an included angle, to the connecting rod sheet.

As shown in FIG. 3, in some embodiments of the disclosure, the supporting arm further includes a guide sleeve 23 and a guide rod 22. The guide rod 22 is in sliding fit with the guide sleeve 23.

The force applying member is located an outer circumference of both the guide sleeve 23 and the guide rod 22, such that the force applying member is guided.

Through the above arrangement, the guide rod 22 and the guide sleeve 23 may provide a guiding function for the force applying member, such that a problem of instability of the compression spring located at the inner side when the force applying member is compressed can be prevented.

Specifically, in some embodiments of the disclosure, the stopping member 25 is in threaded fit with the guide rod 22, and the supporting arm further includes a knob connected to the guide rod 22, such that the stopping member 25 can be moved by rotating the guide rod.

Specifically, in some embodiments of the disclosure, the guide sleeve 23 is connected to the connecting member 24, the connecting member 24 is pivot-connected to the second connecting rod 12, and the guide rod 22 is connected to the first connecting rod 11 or the first mounting seat 1, such that the stopping member 25 is connected to the first connecting rod 11 or the first mounting seat 1.

As shown in FIG. 2, in some embodiments of the disclosure, the supporting arm further includes a housing 30 connected to the supporting member 10. The number of the supporting member 10 is two, the housing 30 covers an outer circumference of two supporting members 10 and the force applying member. In this way, the force applying member and the supporting members 10 may be prevented from being exposed, such that overall appearance of the supporting arm can be improved.

As shown in FIG. 2, in some embodiments of the disclosure, the housing 30 includes an upper cover plate, a left cover plate and a right cover plate that are connected and arranged at an included angle, so as to form a U-shaped structure provided with a mounting cavity. In this way, the housing may shield an upper side, a left side and a right side of the supporting member 10 and the force applying member, and the supporting member 10 and the force applying member may be conveniently mounted from a lower side of the housing 30.

As shown in FIG. 2, in some embodiments of the disclosure, the supporting arm further includes a lower cover plate 31 connected to the supporting member 10, and the lower cover plate 31 is located on a bottom of the supporting member 10. In this way, a lower side of both the supporting member 10 and the force applying member can be shielded.

As shown in FIG. 2, in some embodiments of the disclosure, the number of the supporting members 10 is two, and the two supporting members 10 are located at a left side and a right side of the force applying member, respectively. In this way, overall stability of the supporting arm can be improved.

Specifically, in some embodiments of the disclosure, two first connecting rods 11 are integrally formed, and two second connecting rods 12 are separately arranged, such that mounting is facilitated.

Specifically, in some embodiments of the disclosure, the first connecting rod 11 and the second connecting rod 12 are both pivotally connected to the first mounting seat 1 by hinge pins. The first connecting rod 11 and the second connecting rod 12 are both pivotally connected to the second mounting seat 2 by means of hinge pins. The connecting member 24 is rotatably connected to the hinge pins on the two second connecting rods 12.

It may be seen from the above description that the embodiments of the disclosure achieve the following technical effects: in the prior art, a spring having a large size is used to increase bearing capacity of a display support, compared with that, a large spring is transformed into a plurality of small elastic members for nested mounting from inside to outside in the embodiments of the present disclosure, and the plurality of elastic members jointly provide the supporting force. In this way, on one hand, internal space of the elastic members can be used, which not only increases bearing capacity of the supporting arm, but also avoids increase in a size of the supporting arm; and on the other hand, under the condition that the springs occupy the same space as the spring in the prior art, the supporting arm in the embodiment has a larger bearing range, and the bearing range of the supporting arm can be increased by increasing the number of elastic members.

What are described above are some embodiments of the disclosure and are not intended to limit the disclosure, and those skilled in the art can make various modifications and changes to the disclosure. Any modifications, equivalent substitutions, improvements, etc. within the spirit and principles of the disclosure are intended to fall within the protection scope of the disclosure.

1. A supporting arm comprising:
a first mounting seat;
a second mounting seat;
a supporting member, wherein two opposite ends of the supporting member are configured to be rotatably connected to the first mounting seat and the second mounting seat, respectively; and
a force applying member arranged between the first mounting seat and the second mounting seat, wherein the force applying member comprises at least two elastic members nested sequentially from inside to outside, and the at least two elastic members jointly provide a supporting force, such that the second mounting seat is kept at any rotation position of the first mounting seat.

2. The supporting arm as claimed in claim 1, wherein:
at least one side of the force applying member is provided with the supporting member, the supporting member comprises a first connecting rod and a second connecting rod, a first end of the first connecting rod and a first end of the second connecting rod are both pivotally connected to the first mounting seat, a second end of the first connecting rod and a second end of the second connecting rod are both pivotally connected to the second mounting seat, and the first connecting rod, the second connecting rod, the first mounting seat and the second mounting seat form a quadrilateral structure; and
the quadrilateral structure is kept at any deformation position by the force applying member.

3. The supporting arm as claimed in claim 2, further comprising:
a connecting member connected to the second connecting rod; and
a stopping member connected to the first connecting rod or the first mounting seat,
wherein the at least two elastic members are located between the connecting member and the stopping member, and two opposite ends of each of the at least two elastic members are connected to the connecting member and the stopping member, respectively.

4. The supporting arm as claimed in claim 3, wherein:
the at least two elastic members are two compression springs,
the stopping member comprises a first stopping section and a second stopping section that are connected to each other,
a cross-sectional area of the first stopping section is larger than a cross-sectional area of the second stopping section,
a compression spring located at an outer side of the two compression springs sleeves the second stopping section and abuts against the first stopping section, and
a compression spring located at an inner side of the two compression springs abuts against the second stopping section.

5. The supporting arm as claimed in claim 3, wherein the stopping member comprises at least two stopping sections which are connected and whose cross-sectional areas decrease sequentially, and the at least two elastic members correspondingly abut against the at least two stopping sections.

6. The supporting arm as claimed in claim 3, wherein the stopping member is movably arranged along an axis of the elastic members, a side of the second connecting rod facing the force applying member is provided with a guide groove, and the stopping member is in sliding fit with the guide groove.

7. The supporting arm as claimed in claim 2, further comprising a limiting member connected to the second connecting rod, wherein at least part of the limiting member is arranged at an included angle with the second connecting rod, and the limiting member is at least located at a circumferential side of the force applying member, such that the force applying member is prevented from falling off.

8. The supporting arm as claimed in claim 1, further comprising:
a guide sleeve; and
a guide rod in sliding fit with the guide sleeve, wherein the force applying member is located on an outer circumference of both the guide sleeve and the guide rod, such that the force applying member is to be guided.

9. The supporting arm as claimed in claim 1, further comprising a housing connected to the supporting member, wherein the housing covers an outer circumference of two supporting members and the force applying member.

10. The supporting arm as claimed in claim 9, wherein:
the housing comprises an upper cover plate, a left cover plate and a right cover plate that are connected and arranged at an included angle, so as to form a U-shaped structure provided with a mounting cavity; or
the supporting arm further comprises a lower cover plate connected to the supporting member, and the lower cover plate is located on a bottom of the supporting member; or
a number of the supporting members is two, and the two supporting members are located at a left side and a right side of the force applying member, respectively.

11. The supporting arm as claimed in claim 8, wherein:
at least one side of the force applying member is provided with the supporting member, the supporting member comprises a first connecting rod and a second connecting rod, a first end of the first connecting rod and a first end of the second connecting rod are both pivotally connected to the first mounting seat, a second end of the first connecting rod and a second end of the second connecting rod are both pivotally connected to the second mounting seat, and the first connecting rod, the second connecting rod, the first mounting seat and the second mounting seat form a quadrilateral structure; and
the quadrilateral structure is kept at any deformation position by the force applying member.

12. The supporting arm as claimed in claim 11, further comprising:
a connecting member connected to the second connecting rod; and
a stopping member connected to the first connecting rod or the first mounting seat, wherein the at least two elastic members are located between the connecting member and the stopping member, and two opposite ends of each of the at least two elastic members are connected to the connecting member and the stopping member, respectively.

13. The supporting arm as claimed in claim 12, wherein:
the at least two elastic members are two compression springs,
the stopping member comprises a first stopping section and a second stopping section that are connected to each other,
a cross-sectional area of the first stopping section is larger than a cross-sectional area of the second stopping section,
a compression spring located at an outer side of the two compression springs sleeves the second stopping section and abuts against the first stopping section, and
a compression spring located at an inner side of the two compression springs abuts against the second stopping section.

14. The supporting arm as claimed in claim 12, wherein the stopping member comprises at least two stopping sections which are connected and whose cross-sectional areas decrease sequentially, and the at least two elastic members correspondingly abut against the at least two stopping sections.

15. The supporting arm as claimed in claim 12, wherein the stopping member is movably arranged along an axis of the elastic members, a side of the second connecting rod facing the force applying member is provided with a guide groove, and the stopping member is in sliding fit with the guide groove.

16. The supporting arm as claimed in claim 11, further comprising a limiting member connected to the second connecting rod,
wherein at least part of the limiting member is arranged at an included angle with the second connecting rod, and the limiting member is at least located at a circumferential side of the force applying member, such that the force applying member is prevented from falling off.
